(19) United States
(12) Patent Application Publication
(10) Pub. No.: US 2016/0327631 A1
(43) Pub. Date: Nov. 10, 2016

(54) DETERMINATION OF A LOCATION OF A DEVICE

(71) Applicant: NOKIA TECHNOLOGIES OY, Espoo (FI)

(72) Inventors: Juha SALOKANNEL, TAMPERE (FI); Jukka Ilmari RANTALA, Espoo (FI); Jouni Jyrki Aleksi KÄMÄRÄINEN, Helsinki (FI)

(21) Appl. No.: 15/109,523

(22) PCT Filed: Jan. 15, 2014
(86) PCT No.: PCT/FI2014/050026

§ 371 Date: Jul. 1, 2016

(51) Int. Cl. G01S 5/12

(52) U.S. Cl. CPC G01S 5/12

(57) ABSTRACT

A method comprises enabling receipt, at a multi-antenna array device (10) from a remote device (30), of at least one wirelessly transmitted packet including location data (38) indicative of a location of the remote device (80) and an angle-of-arrival field (39) for enabling determination of an angle of arrival of the wirelessly transmitted packet in which the angle-of-arrival field (39) is provided, determining based on the received angle of arrival field (39), the angle of arrival of the wirelessly transmitted packet in which the angle-of-arrival field (39) is provided, and determining a location of the multi-antenna array device (10) based on at least the determined angle of arrival and the location data.

### FIELD

This specification relates to the determination of a location of a device.

### BACKGROUND

High accuracy indoor positioning requires novel systems and solutions that are specifically developed for indoor positioning. The “traditional” positioning technologies used mainly outdoors, such as GPS, WiFi- and cellular-positioning technologies, generally cannot deliver a satisfactory performance indoors that would enable seamless navigation experience in both environments. Typically, there are issues with accuracy, coverage and floor detection (3D) that are difficult to achieve with systems and signals that were not originally designed for the indoor use cases.

One the of the most promising new solutions for 3D indoor positioning is based on Bluetooth Low Energy (BT LE) technology using an array phased antennas. The antenna array measures the angle-of-departure (AoD) or angle-of-arrival (AoA). Based on this, and additional constraint information, the 3D position of a device can be determined.

### SUMMARY

In a first aspect, this specification describes a method comprising: enabling receipt, at a multi-antenna array device from a remote device, of at least one wirelessly transmitted packet including location data indicative of a location of the remote device and an angle-of-arrival field for enabling determination of an angle of arrival of the wirelessly transmitted packet in which the angle-of-arrival field is provided; determining based on the received angle of arrival field, the angle of arrival of the wirelessly transmitted packet in which the angle-of-arrival field is provided; and determining a location of the multi-antenna array device based on at least the determined angle of arrival and the location data.

The location data may include coordinate information indicative of the coordinates of the remote device, elevation information indicative of an elevation of the remote device and/or information indicative of a storey on which the remote device is located.

The location data and the angle-of-arrival field may be provided in the same wirelessly-transmitted packet.

Alternatively, the location data may be provided in a location data packet and the angle-of-arrival field may be provided in a separately-transmitted positioning packet. The location data packet may include information indicative of a transmission channel of the positioning packet and/or a transmission interval associated with the positioning packet. The location data packet may be a Bluetooth Low Energy advertising packet. The positioning packet may be a Bluetooth Low Energy broadcast packet.

Determining the location of the multi-antenna array device may be based on an assumed orientation of the multi-antenna array device or a detected orientation of the multi-antenna array device. Alternatively, the method may further comprise: enabling receipt at the multi-antenna array device from a second remote device of at least one wirelessly transmitted packet including location data indicative of a location of the second remote device and a second angle-of-arrival field; determining based on the received second angle-of-arrival field, an angle of arrival of the wirelessly transmitted packet in which the second angle-of-arrival field is provided; enabling receipt at the multi-antenna array device from a third remote device, of at least one wirelessly transmitted packet including location data indicative of a location of the third remote device and a third angle-of-arrival field; determining based on the received third angle-of-arrival field, an angle of arrival of the wirelessly transmitted packet in which the third angle-of-arrival field is provided; and determining the location of the multi-antenna array device based on at least the angles of arrival of the wirelessly-transmitted packet in which the angle-of-arrival field is provided, the wirelessly-transmitted packet in which the second angle-of-arrival field is provided and the wirelessly-transmitted packet in which the third angle-of-arrival field is provided and on the locations of the remote device, the second remote device and the third remote device.

The multi-antenna array device may be a mobile device. The remote device may be a BLE-capable tag.

In a second aspect, this specification describes a method comprising: causing transmission from a remote device of at least one wirelessly transmitted packet including location data indicative of a location of the remote device and an angle-of-arrival field for enabling a multi-antenna array device to determine an angle of arrival, at the multi-antenna array device, of the wirelessly transmitted packet in which the angle-of-arrival field is transmitted.

The location data may include coordinate information indicative of the coordinates of the remote device, elevation information indicative of an elevation of the remote device and/or information indicative of a storey on which the remote device is located.

The location data and the angle-of-arrival field may be caused to be transmitted in the same wirelessly-transmitted packet.

Alternatively, the location data may be caused to be transmitted in a location data packet and the angle-of-arrival field may be provided in a separately-transmitted positioning packet. The location data packet may include information indicative of a transmission channel of the positioning packet and/or a transmission interval associated with the positioning packet. The location data packet may be a Bluetooth Low Energy advertising packet. The positioning packet may be a Bluetooth Low Energy broadcast packet.

In a third aspect, this specification describes apparatus comprising: at least one processor; and at least one memory including computer program code, the at least one memory and the computer program code configured to, with the at least one processor, cause the apparatus at least: to enable receipt, at a multi-antenna array device from a remote device, of at least one wirelessly transmitted packet including location data indicative of a location of the remote device and an angle-of-arrival field for enabling determination of an angle of arrival of the wirelessly transmitted packet in which the angle-of-arrival field is provided; to determine based on the received angle of arrival field, the angle of arrival of the wirelessly transmitted packet in which the angle-of-arrival field is provided; and to determine a location of the multi-antenna array device based on at least the determined angle of arrival and the location data.

The location data may include coordinate information indicative of the coordinates of the remote device, elevation information indicative of an elevation of the remote device and/or information indicative of a storey on which the remote device is located.

The location data and the angle-of-arrival field may be provided in the same wirelessly-transmitted packet.

Alternatively, the location data may be provided in a location data packet and the angle-of-arrival field may be provided in a separately-transmitted positioning packet. The location data packet may include information indicative of a transmission channel of the positioning packet and/or a transmission interval associated with the positioning packet.

The location data packet may be a Bluetooth Low Energy advertising packet. The positioning packet may be a Bluetooth Low Energy broadcast packet.

The at least one memory and the computer program code may be configured to, with the at least one processor, cause the apparatus to determine the location of the multi-antenna array device based on an assumed orientation of the multi-antenna array device or a detected orientation of the multi-antenna array device. Alternatively, the at least one memory and the computer program code may be configured to, with the at least one processor, cause the apparatus: to enable receipt at the multi-antenna array device from a second remote device of at least one wirelessly transmitted packet including location data indicative of a location of the second remote device and a second angle-of-arrival field; to determine based on the received second angle-of-arrival field, an angle of arrival of the wirelessly transmitted packet in which the second angle-of-arrival field is provided; to enable receipt at the multi-antenna array device from a third remote device, of at least one wirelessly transmitted packet including location data indicative of a location of the third remote device and a third angle-of-arrival field; to determine based on the received third angle-of-arrival field, an angle of arrival of the wirelessly transmitted packet in which the third angle-of-arrival field is provided; and to determine the location of the multi-antenna array device based on at least the angles of arrival of the wirelessly-transmitted packet in which the angle-of-arrival field is provided, the wirelessly-transmitted packet in which the second angle-of-arrival field is provided and the wirelessly-transmitted packet in which the third angle-of-arrival field is provided and on the locations of the remote device, the second remote device and the third remote device.

The multi-antenna array device may be a mobile device. The remote device may be a BLE-capable tag.

In a fourth aspect, this specification describes apparatus comprising: at least one processor; and at least one memory including computer program code, the at least one memory and the computer program code configured to, with the at least one processor, cause the apparatus at least: to cause transmission from a remote device of at least one wirelessly transmitted packet including location data indicative of a location of the remote device and an angle-of-arrival field for enabling a multi-antenna array device to determine an angle of arrival, at the multi-antenna array device, of the wirelessly transmitted packet in which the angle-of-arrival field is transmitted.

The location data may include coordinate information indicative of the coordinates of the remote device, elevation information indicative of an elevation of the remote device and/or information indicative of a storey on which the remote device is located.

The location data and the angle-of-arrival field may be caused to be transmitted in the same wirelessly-transmitted packet.

Alternatively, the location data may be caused to be transmitted in a location data packet and the angle-of-arrival field may be provided in a separately-transmitted positioning packet. The location data packet may include information indicative of a transmission channel of the positioning packet and/or a transmission interval associated with the positioning packet. The location data packet may be a Bluetooth Low Energy advertising packet. The positioning packet may be a Bluetooth Low Energy broadcast packet.

In a fifth aspect, this specification describes a non-transitory computer-readable storage medium having stored thereon computer-readable code, which, when executed by computing apparatus, causes the computing apparatus to perform a method comprising: enabling receipt, at a multi-antenna array device from a remote device, of at least one wirelessly transmitted packet including location data indicative of a location of the remote device and an angle-of-arrival field for enabling determination of an angle of arrival of the wirelessly transmitted packet in which the angle-of-arrival field is provided; determining based on the received angle of arrival field, the angle of arrival of the wirelessly transmitted packet in which the angle-of-arrival field is provided; and determining a location of the multi-antenna array device based on at least the determined angle of arrival and the location data. The computer-readable code, when executed by computing apparatus, may cause the computing apparatus to perform any method described with reference to the first aspect.

In a sixth aspect, this specification describes a non-transitory computer-readable storage medium having stored thereon computer-readable code, which, when executed by computing apparatus, causes the computing apparatus to perform a method comprising: causing transmission from a remote device of at least one wirelessly transmitted packet including location data indicative of a location of the remote device and an angle-of-arrival field for enabling a multi-antenna array device to determine an angle of arrival, at the multi-antenna array device, of the wirelessly transmitted packet in which the angle-of-arrival field is transmitted. The computer-readable code, when executed by computing apparatus, may cause the computing apparatus to perform any method described with reference to the second aspect.

In a seventh aspect, this specification describes apparatus configured: to enable receipt, at a multi-antenna array device from a remote device, of at least one wirelessly transmitted packet including location data indicative of a location of the remote device and an angle-of-arrival field for enabling determination of an angle of arrival of the wirelessly transmitted packet in which the angle-of-arrival field is provided; to determine based on the received angle of arrival field, the angle of arrival of the wirelessly transmitted packet in which the angle-of-arrival field is provided; and to determine a location of the multi-antenna array device based on at least the determined angle of arrival and the location data.

The location data may include coordinate information indicative of the coordinates of the remote device, elevation information indicative of an elevation of the remote device and/or information indicative of a storey on which the remote device is located.

The location data and the angle-of-arrival field may be provided in the same wirelessly-transmitted packet.

Alternatively, the location data may be provided in a location data packet and the angle-of-arrival field may be provided in a separately-transmitted positioning packet. The location data packet may include information indicative of a transmission channel of the positioning packet and/or a transmission interval associated with the positioning packet. The location data packet may be a Bluetooth Low Energy advertising packet. The positioning packet may be a Bluetooth Low Energy broadcast packet.

The apparatus may be configured to determine the location of the multi-antenna array device based on an assumed orientation of the multi-antenna array device or a detected orientation of the multi-antenna array device. Alternatively, the apparatus may be configured: to enable receipt at the multi-antenna array device from a second remote device of at least one wirelessly transmitted packet including location data indicative of a location of the second remote device and a second angle-of-arrival field; to determine based on the received second angle-of-arrival field, an angle of arrival of the wirelessly transmitted packet in which the second angle-of-arrival field is provided; to enable receipt at the multi-antenna array device from a third remote device, of at least one wirelessly transmitted packet including location data indicative of a location of the third remote device and a third angle-of-arrival field; to determine based on the received third angle-of-arrival field, an angle of arrival of the wirelessly transmitted packet in which the third angle-of-arrival field is provided; and to determine the location of the multi-antenna array device based on at least the angles of arrival of the wirelessly-transmitted packet in which the angle-of-arrival field is provided, the wirelessly-transmitted packet in which the second angle-of-arrival field is provided and the wirelessly-transmitted packet in which the third angle-of-arrival field is provided and on the locations of the remote device, the second remote device and the third remote device.

The multi-antenna array device may be a mobile device. The remote device may be a BLE-capable tag.

In an eighth aspect, this specification describes apparatus configured to cause transmission from a remote device of at least one wirelessly transmitted packet including location data indicative of a location of the remote device and an angle-of-arrival field for enabling a multi-antenna array device to determine an angle of arrival, at the multi-antenna array device, of the wirelessly transmitted packet in which the angle-of-arrival field is transmitted.

The location data may include coordinate information indicative of the coordinates of the remote device, elevation information indicative of an elevation of the remote device and/or information indicative of a storey on which the remote device is located.

The location data and the angle-of-arrival field may be caused to be transmitted in the same wirelessly-transmitted packet.

Alternatively, the location data may be caused to be transmitted in a location data packet and the angle-of-arrival field may be provided in a separately-transmitted positioning packet. The location data packet may include information indicative of a transmission channel of the positioning packet and/or a transmission interval associated with the positioning packet. The location data packet may be a Bluetooth Low Energy advertising packet. The positioning packet may be a Bluetooth Low Energy broadcast packet.

In a ninth aspect, this specification describes a portable multi-antenna device comprising any apparatus as described with reference to the third and seventh aspects.

In a tenth aspect, this specification describes a transmission device comprising any apparatus as described with reference to the fourth and eighth aspects.

In an eleventh aspect, this specification describes computer-readable code which, when executed by computing apparatus, causes the computing apparatus to perform a method as described in either of the first and second aspects.

In a twelfth aspect, this specification describes apparatus comprising means for enabling receipt, at a multi-antenna array device from a remote device, of at least one wirelessly to transmitted packet including location data indicative of a location of the remote device and an angle-of-arrival field for enabling determination of an angle of arrival of the wirelessly transmitted packet in which the angle-of-arrival field is provided; means for determining based on the received angle of arrival field, the angle of arrival of the wirelessly transmitted packet in which the angle-of-arrival field is provided; and means for determining a location of the multi-antenna array device based on at least the determined angle of arrival and the location data. The apparatus may further comprise means for performing any of the operations described with reference to the first aspect.

In a thirteenth aspect, this specification describes apparatus comprising means for causing transmission from a remote device of at least one wirelessly transmitted packet including location data indicative of a location of the remote device and an angle-of-arrival field for enabling a multi-antenna array device to determine an angle of arrival, at the multi-antenna array device, of the wirelessly transmitted packet in which the angle-of-arrival field is transmitted. The apparatus may further comprise means for performing any of the operations described with reference to the second aspect.

### BRIEF DESCRIPTION OF THE FIGURES

For a more complete understanding of examples of embodiments of the present invention, reference is now made to the following descriptions taken in connection with the accompanying drawings in which:

FIG. 1 illustrates an apparatus according to aspects of the invention receiving radio signals from a transmission apparatus according to other aspects of the invention;

FIG. 2A is a schematic diagram of an example of transmission apparatus according to aspects of the invention;

FIG. 2B is a schematic diagram of an example of a multi-antenna array apparatus according to other aspects of the invention;

FIG. 3 is a flow chart illustrating examples of operations which may be performed by processing circuitry of the transmission apparatus of FIG. 2A;

FIG. 4 is a flow chart illustrating examples of operations which may be performed by processing circuitry of the apparatus of FIG. 2B;

FIG. 5 is a schematic illustration of apparatus according to aspects of the invention which utilises triangulation to determine a location of a device;

FIGS. 6A and 6B illustrate examples of formats of wirelessly transmitted data packets which may be transmitted or received according to various aspects of the invention; and

FIG. 7 illustrates estimating the position using a displacement or range as a constraint.

### DETAILED DESCRIPTION OF EXAMPLES OF EMBODIMENTS OF THE INVENTION

In the description and drawings, like reference numerals may refer to like elements throughout.

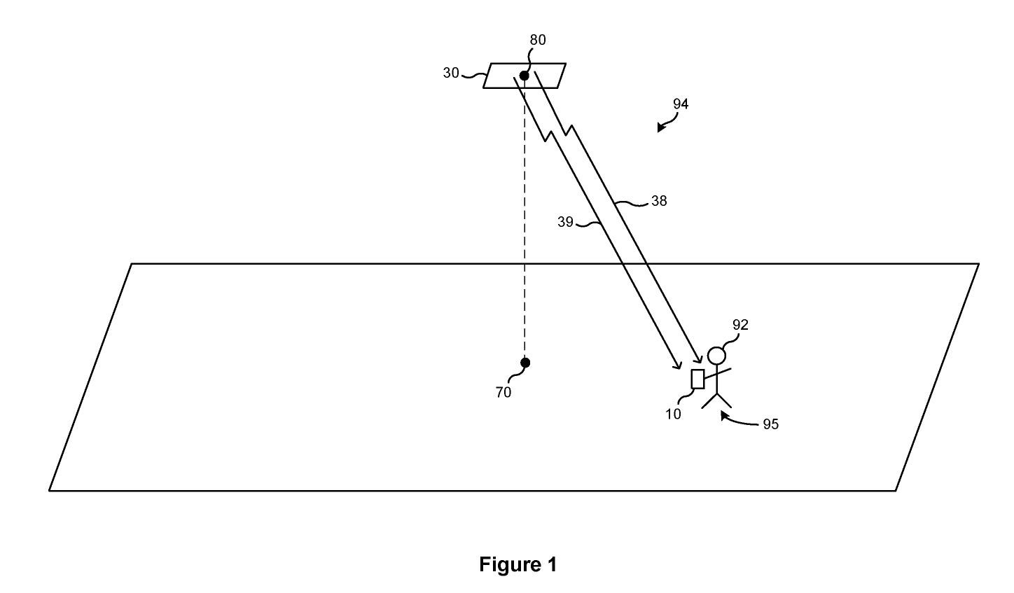

FIG. 1 illustrates a person 92 (carrying a mobile radio communications apparatus 10) at a position 95 on a floor 100 of a building 94. The building 94 could be, for example, a shopping centre or a conference centre.

A transmitting apparatus 30 is provided at a location 80 of the building 94. In the illustrated example, the location 80 is on the ceiling of the building 94 (i.e. the overhead interior surface) but in other implementations the transmitting apparatus 30 may be placed elsewhere, such as on a wall or within an under-floor cavity. For reasons that will become apparent, the transmission apparatus 30 can be termed positioning data transmission apparatus 30. As the transmission apparatus 30 is remote from the mobile radio communications apparatus 10, the transmission apparatus may also be referred to as remote device 10. Also for reasons that will become apparent, the mobile radio communications apparatus 10 can be termed a multi-antenna array device 10.

The location 80 is directly above the point denoted with the reference numeral 70 on the floor 100 of the building. The positioning data transmission apparatus 30 is for enabling the position of the mobile radio communications apparatus 10 to be determined. In some examples, this may be the sole purpose of the transmission apparatus 30, in which case it may be termed a positioning tag 30. In other examples, however, the transmission apparatus 30 may have additional functionality. For example, the transmission apparatus may be part of a transceiver for providing wireless internet access to users of mobile radio communications apparatus 10, for example, via Bluetooth Low Energy protocol signals or wireless local area network (WLAN) radio signals.

Briefly, the transmission apparatus 30 is configured (or operable) to cause transmission of at least one signal 38, 39 which is received at the mobile radio communications apparatus 10 (which will hereafter be referred to as “mobile device 10”). The mobile device 10 is configured to enable receipt of at least one radio signal 38, 39 that is transmitted by the transmission apparatus 30, for instance a Bluetooth Low Energy protocol signal. Although the specific embodiments described herein are directed primarily to Bluetooth Low Energy, it will be appreciated that the one or more signals transmitted and/or received in accordance with the invention may be based on a different wireless to transmission protocol, such as but not limited to a protocol in accordance with one of the IEEE 802.11 specifications.

The signals transmitted by the transmission apparatus 30 include at least one wirelessly-transmitted packet 38, 39 which contains location data indicative of a location of the transmission apparatus 30 and an angle-of-arrival field which enables the mobile device 10 to determine an angle of arrival, at the mobile device 10 from the transmission apparatus 30, of the packet in which the angle-of-arrival field is transmitted.

The location data and the angle-of-arrival field may be transmitted by the transmission apparatus 30 in a single wirelessly transmitted packet or may be transmitted in two separate packets 38, 39. A packet containing the location data and not the angle-of-arrival field is hereafter referred to as a location data packet 38. A packet containing the angle-of-arrival field and not the location data is hereafter referred to as a positioning packet 39. The positioning packet 39 may be referred to as a Direction of Arrival (DoA) or Angle of Arrival (AoA) positioning packet. The mobile device 10 is configured to determine its position based on at least the angle of arrival of the packet including the angle-of-arrival field and the location data indicative of the location of the transmission apparatus 30. The determined position of the mobile device is relative to the transmission apparatus 30.

The location data contained in the location data packet 38 in some specific examples includes coordinate information (for example, WGS84 coordinates) indicative of the location coordinates of the transmission apparatus 30. The location data also includes elevation information indicative of an elevation of the transmission apparatus 30. The location data may also include level or floor information indicative of a level, floor or storey of a building on which the transmission apparatus 30 is located.

The location of the mobile device may be determined using the determined position of the mobile device 10 relative to the transmission apparatus 30 and orientation information indicative of the orientation of the mobile device 10. The orientation information may be an assumed orientation of the mobile device 10 or a detected orientation of the mobile device 10. The detected orientation, in some examples, is detected using a compass module of the mobile device 10. Alternatively, the determination of the location of the mobile device may be based on triangulation using on locations of, and angles of arrival of packets from, each of three different transmitting apparatuses 30.

In embodiments in which separate packets are used to transmit the location data and the angle-of-arrival field, the location data packet 38 may include information indicative of a transmission channel associated with transmissions of the positioning packet 39 and/or a transmission interval associated with transmissions of the positioning packet 39. In embodiments which are implemented using BLE, the he location data packet may be a Bluetooth Low Energy (BLE) advertising packet. In such embodiments, the positioning packet may be a Bluetooth Low Energy broadcast packet.

Embodiments of the invention allow positioning functionality to be provided in an indoor space without requiring a complex fixed infrastructure (including fixed multi-antenna array devices) to be installed in that space. Instead, one or more simple and cheap positioning tags can be installed. In addition, as the tags may utilise single antenna only the orientation at which the tags are installed may not be important. As such, the installation process of the infrastructure for providing indoor positioning is also simplified.

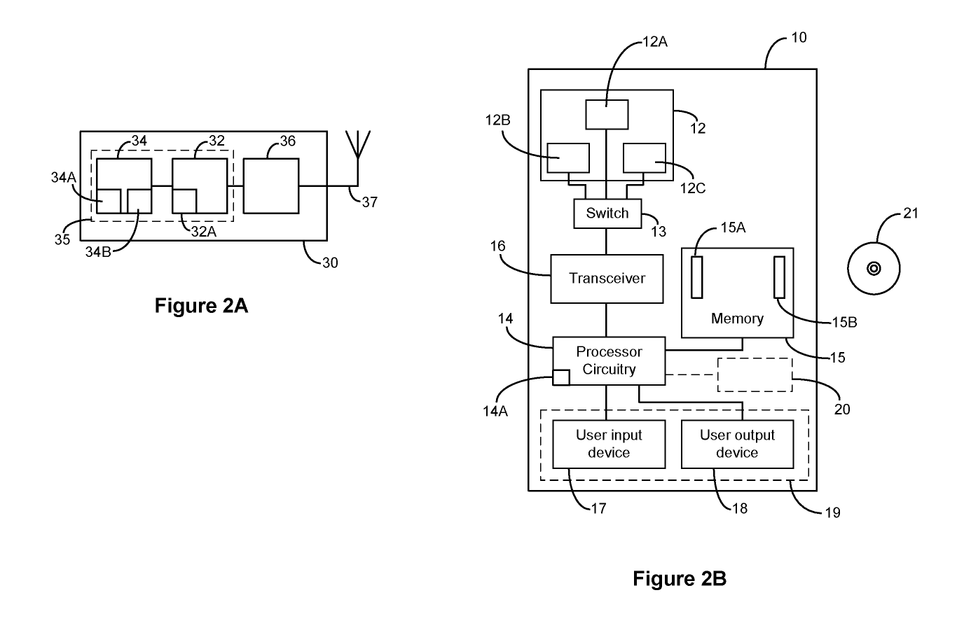

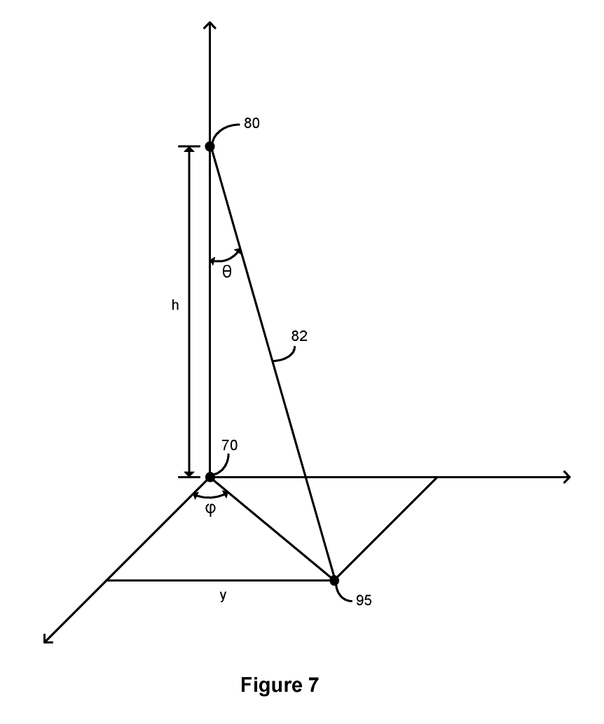

The mobile device 10, which as noted above may also be referred to as a multi-antenna array device 10, is configured to determine the Angle of Arrival (which may also be referred to as the “bearing”) of the packet in which the angle-or-arrival field is contained similarly to the way in which the Angle of Arrival of a positioning packet is determined in WO2012/042315 A1, which is hereby incorporated by reference. Briefly, the transmission apparatus 30 transmits a packet including the angle-of-arrival field, for instance using Bluetooth Low Energy, which is received at the mobile device 10. The mobile device 10 switches between the antenna elements in its multi-antenna array when receiving the angle-of-arrival field and takes I and Q samples for the signal portions, each of which carries a portion of the angle-of-arrival field, received at each antenna element. The mobile device 10 then compares the I and Q samples with calibration data 15B (see FIG. 2B) of the antenna elements and, based on this, estimates the azimuth angle φ and elevation angle θ (see FIG. 7), which define the angle of arrival 82 of the packet.

FIG. 2A is a simplified schematic of an example of the transmission apparatus 30 of FIG. 1. FIG. 2B is a simplified schematic of an example of the mobile radio communications apparatus 10.

The transmission apparatus 30 of the example of FIG. 2A comprises a controller 35, a transceiver 36 and an antenna 37. The controller 35 is configured to control the to transceiver 36 to transmit via the antenna 37 the at least one wirelessly transmitted packet 38, 39. In some specific embodiments, the at least one wirelessly transmitted packet comprise a location data packet 38 and a separately-transmitted positioning packet 39. In some examples in which the apparatus 30 in its most simple form, the transceiver 36 may be replaced by a transmitter such that the apparatus 30 does not have receiving capabilities.

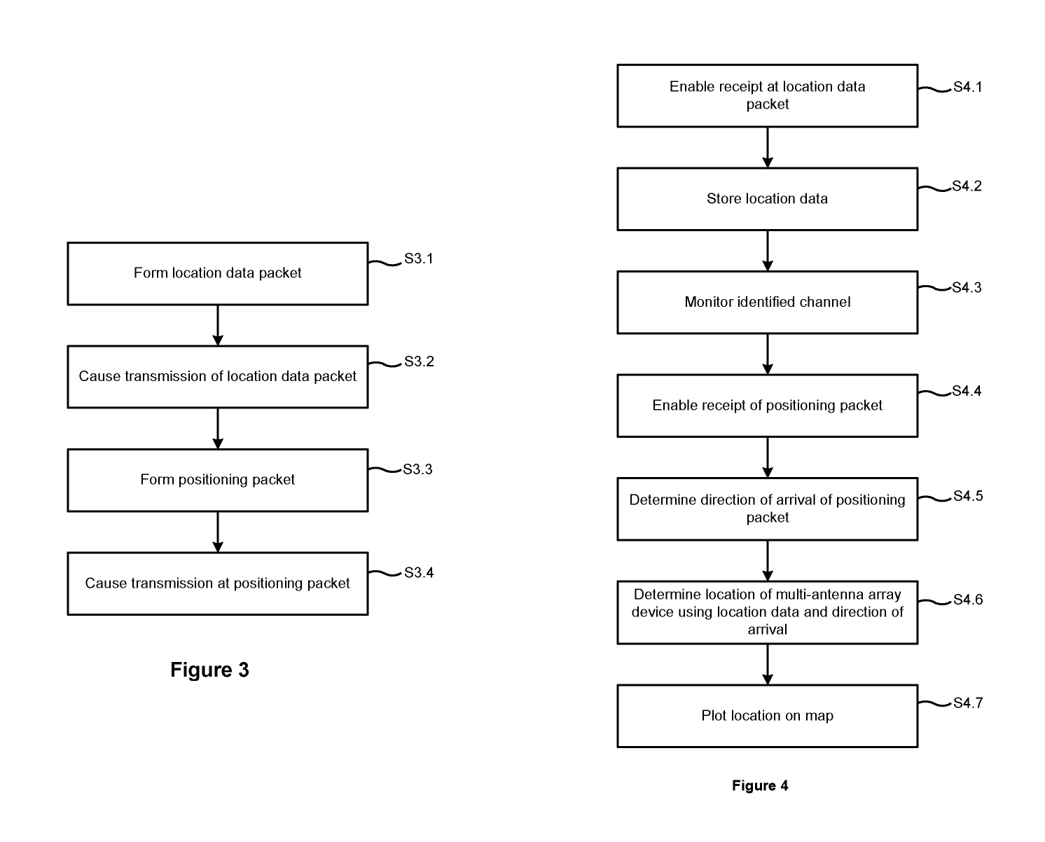

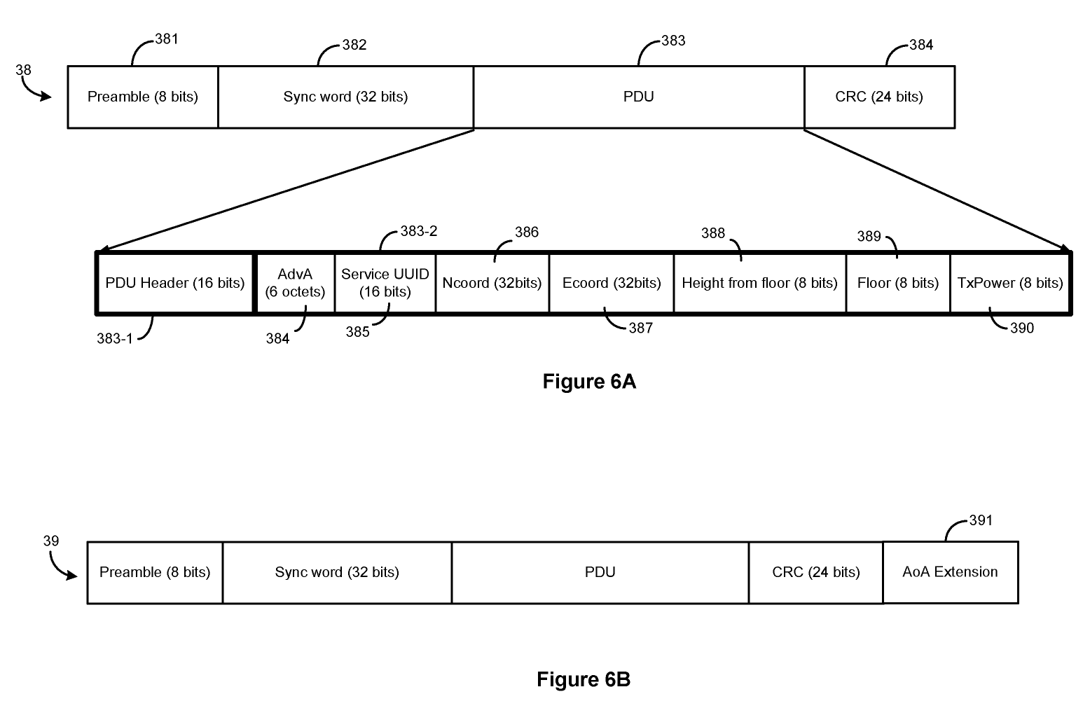

The controller 35 may be of any suitable construction but, in this example, the controller 35 comprises processing circuitry 32 and a storage device 34. The processing circuitry 32 is configured, under the control of computer-readable code 34A stored on the storage device 34, to control the operation of the transmission apparatus 30 to perform the methods described with reference to FIG. 3. The transmission apparatus 30 may be referred to as a “single antenna apparatus”. This is because, although the transmission apparatus 30 may be part of a device having multiple antennas, only a single antenna may be used to perform operations such as those described with reference to FIGS. 3 and 6A and 6B.

The storage device 34 includes location data 34B indicative of the location of the transmission apparatus 30. In some cases, this is loaded onto the storage device 34 prior to installing the transmission apparatus 30 at the location. In other examples, which may simplify the installation process by requiring less precise positioning of the apparatus, the location data is loaded onto the storage device after the apparatus has been installed at the location. This may be done in any suitable way.

In examples in which the transmission apparatus 30 is a positioning tag, the tag 30 additionally comprises a power source (not shown) such as a battery. In other examples, the apparatus 30 receives power from an external source.

The transmission apparatus 30 is in some specific examples configured to transmit signals via the Bluetooth Low Energy protocol. That is to say the apparatus 30 is able to operate in accordance with the BLE standard, currently at version 4.0. Put another way, the apparatus 30 is “BLE-capable”.

The current BLE standard defines packets of different types. One such type is known as an advertising packet and these are transmitted on any of three different advertising channels. Typically, advertising packets are used to indicate the presence of a BLE-capable device or apparatus to another BTLE-capable device or apparatus. Advertising to packets include an identifier, which identifies the transmitting device. In addition, an advertising packet may include a channel identifier, which indicates to a receiving device or apparatus a different channel on which the transmitting device will transmit a subsequent packet. The subsequent message may be referred to as a broadcast packet. Advertising packets may be transmitted relatively infrequently compared to the frequency of transmission of the broadcast packets. For example, an advertising packet may be transmitted every 1000 milliseconds and a broadcast packet may be transmitted every 20 milliseconds. In this way, a transmitting device or apparatus 30 is able to indicate its presence to a receiving device or apparatus on one of the advertising channels and then can transmit the data of interest using a broadcasting message on a different channel. This helps to avoid congestion of the three advertising channels.

In some specific examples, the transmitting apparatus 30 is capable of transmitting both advertising packets and broadcast packets and the mobile device 10 is capable of receiving these packets and deciphering the data therein. In such examples, the location data packet 38 may be an advertising packet and the positioning packet 39 may be a broadcast packet 39. Although this may be beneficial, it will be appreciated that this may not necessarily be the case. For instance, in some examples, the positioning packet 39 may be an advertising packet or a multicast packet. Similarly, the location data packet may be something other than an advertising packet, for instance a broadcast or multicast packet. In examples in which the location data and the angle-of-arrival field are included in the same packet, any suitable packet type may be used. For instance, the location data and the angle-of-arrival field may both be included a single advertising packet, broadcast packet or multicast packet.

In some examples, the location data may be stored in a database (e.g. the Generic Attribute Profile database) of the transmission apparatus 30. As such, the location data may be acquired by the multi-antenna array device 10 over a BLE data channel connection that has been established between the transmission apparatus 30 and the multi-antenna array device 10. Put another way, the location data 10 may be transmitted by the transmission apparatus 30 to the multi-antenna array device 10 in a data channel packet. The database may be stored in the storage device 34 of the transmission apparatus 30. Transmission of the location data over the established data channel connection may be in addition to transmission of the location data in an advertising packet,

The mobile radio communications apparatus 10 of FIG. 2B may, for example, be a hand-held portable electronic device such as, but not limited to a mobile telephone, a tablet computer, a phablet, a navigation device, a media player, and a personal digital assistant.

The apparatus 10 comprises processing circuitry 14 and a storage device 15. The apparatus additionally comprises a transceiver 16. The apparatus 10 also comprises an antenna array 12 comprising a plurality of antenna elements 12A, 12B, 32C which receive the positioning packet 39. At least one of the antenna elements 12A, 12B, 12C is also used to receive the location data packet 38. Although three antenna elements 12A, 12B, 12C are shown, three is the minimum with which the Angle of Arrival can be calculated and the embodiments described herein may include more than three antenna elements. The antenna elements may be arranged in the mobile radio communications apparatus 10 as is described in WO2007/096729 which is also incorporated herein by reference.

Each of the plurality of antenna elements 12A, 12B, 12C is connected to a switch 13, which is controllable by the processing circuitry 14 operating under the control of computer readable code 15A stored in the storage device 15. The switch 13 is controlled so that only one of the antenna elements 12A, 12B, 12C is connected to the transceiver 16 at any one time.

The computer-readable code 15A, when loaded into processing circuitry 14 controls the operation of the mobile radio communications apparatus 10. The computer-readable code 15A provides the logic and routines that enable the apparatus 10 to perform the functionality described above, such as reception of the at least one wirelessly transmitted packet 38, 39, switching of the antenna elements 12A, 12B, 12C, estimation of the Angle of Arrival 82 and determination of the location of the apparatus 10. The computer-readable instructions are configured to cause the apparatus 10 to perform the operations described with reference to FIG. 4.

Also stored in the storage device 15 is calibration data 15B for use in determining the angle of arrival of the positioning packet 39 based on the I and Q samples.

The mobile radio communications apparatus 10 in the specific example of FIG. 2B also comprises a user input device 17 and a user output device 18. The processing circuitry 14 is connected to receive an input from the user input device 17. The processing circuitry 14 is also connected to provide an output to the user output device 18. The user output device 18 is for conveying information to a user and may be, for example, a display device.

The user input device 17 and the user output device 18 together form part of a user interface 19. The user interface 19 may be provided as a single unit, such as a touch screen display device. The user interface 19 also comprises software, which may or may not be integrated with an operating system controlling the apparatus 10.

The apparatus 10 may, in some embodiments, include a compass module 20 for determining an orientation of the apparatus 10. Signals indicative of the orientation may be passed to the processing circuitry 14, which may use the orientation to determine the location of the apparatus 10.

FIG. 3 is a flow chart illustrating an example of operations which may be performed by the processing circuitry 32 of the transmission apparatus 30 of FIG. 2A. The operations will be described also with reference to FIGS. 6A and 6B.

As will become apparent, the flow charts of FIGS. 3 and 4 are directed to specific examples in which location data and the angle-of-arrival field are transmitted in separate packets. However, as has been discussed previously, the location data and angle of arrival field may alternatively be transmitted in a single packet. FIGS. 6A and 6B relate to even more specific examples in which the location packet 38 and positioning packet 39 are a BLE advertising packet and a BLE broadcasting packet respectively. Again, as has been mentioned previously, one or both of the BLE packets may be of different type to those shown or, alternatively, the invention may be implemented using a different transmission protocol, such as Wi-Fi.

In step S3.1, the processing circuitry 32 forms the location data packet 38 for transmission. Formation of the location data packet 38 includes retrieving the location data 34B from the storage device 34 and incorporating this into the packet. The location data 34B, as mentioned above, may include coordinates (for example, WGS84 coordinates) indicative of the location of the transmission apparatus 30. The location data may also include data indicative of the elevation of the transmission apparatus 30. The value of the elevation may be relative to the floor level. Alternatively, the elevation may relative to ground level or sea level or WGS84 ellipsoid. In such examples, the location data may additionally include a value indicative of the elevation of the floor level of the storey in which the transmission apparatus 30 is located. Alternatively or additionally, the location data may include an indication of the floor, storey or level of the building on which the transmission apparatus 30 is located.

The processing circuitry 32 may also include the transmission power in the location data packet.

In some examples, the processing circuitry 32 may also incorporate into the location data packet data relating to the subsequently transmitted positioning packet 39. This may include a value indicative of one or more transmission channels on which the positioning packet 39 is to be broadcast. This may enable the recipient of the location data packet 38 to switch to the correct channel in order to receive the positioning packet 39. A value indicative of a transmission interval of positioning packets may also be incorporated into the location data packets. This enables the recipient to determine how often positioning packets are to be transmitted by the transmission apparatus 30.

FIG. 6A is an example of a location data packet 38 which may be transmitted by the transmission apparatus 30. As mentioned above, the location data packet 38 may, as is the case with this example, be a BLE advertising packet.

The location data packet 38 of FIG. 6A comprises four main parts. The first part 381 is a preamble. The second part is a sync word 382. The third part 383 is a packet data unit (PDU). The fourth part is a cyclic redundancy check (CRC) 384.

Here, the preamble 381 is one octet (eight data bits, also known as one byte). The sync word 382 is four octets. The CRC 384 is three octets. The PDU may be between two and thirty-nine octets.

The PDU includes two main sections 383-1, 383-2. The first is the header 383-1 and the second is the payload 383-2. The header, in this example, has sixteen bits. The payload has nineteen octets. Although not shown in the Figures, the format as the header 383-1 may be as defined in the Bluetooth Specification Version 40.0, Volume 6, section 2.4. As such the header 383-1 may include fields such as a PDU type field (which may indicate that the packet is an advertising packet), one or more fields which are “reserved for future use” (RFU), a TxAdd field, an RxAdd field and a length field (which indicates the length of the payload 383-2.

The payload 383-2 includes an AdvA field 384 (which is 6 octets in length). The AdvA field 384 includes the public or random address of the transmission apparatus 30. The TxAdd field in the header 383-1 indicates whether the address in the AdvA field is public or random.

The payload 383-2 also includes a service UUID field 385, which in this example, is sixteen bits in length. The service UUID field 385 indicates the nature of the data included in the payload 383-2. As such, in this example, the service UUID field 385 indicates that the data includes location data. The service UUID field 385 may further indicate that the location data 38 packet precedes and relates to a positioning packet 39. Put another way, the service UUID field 385, or even another field of the advertising packet, may indicate that separate positioning packets are available. One bit may be sufficient for this indication.

In this example, the location data 34B includes a “North-coordinate” (Ncoord) field 386 and an “East-coordinate” (Ecoord) field 387. The coordinate fields 386, 387 are each, in this example, thirty-two bits in length.

The location data 34B also includes an elevation field 388. In this example, the elevation field 388 indicates the height of the transmission apparatus 30 from the floor of the storey on which the transmission apparatus is located. The elevation field 388 is, in this example, eight bits.

The location data further includes a “floor” field 389, which in this example is eight bits in length. The floor field 389 indicates the storey (or floor or level) of the building on which the transmission apparatus 30 is located.

In this example, the payload 383-2 also includes transmission (Tx) power field 390.

Although not shown in FIG. 6A, the payload 383-2 may further include a “BcstInterval” field indicating the transmission interval of broadcast packets. This field may be for example, one or two octets long. This indicates the interval between transmissions of successive positioning packets 39. Additionally or alternatively, the payload 383-2 may also include a “BcstChannels” field. This may be, for example, three octets in length. This indicates the channels that are used for broadcast the positioning packets 39. The “BcstChannels” field may also be two octets in length.

It will of course be appreciated that the location data packet 38 described with reference to FIG. 6A is an example only and that the packet may include other fields and information which have not been shown or discussed and/or may omit some of the fields that are shown in the Figure.

Returning now to FIG. 3, subsequent to forming the location data packet 38, in step S3-2 the processing circuitry 32 causes the location data packet 38 to be transmitted. In examples in which the location data packet 38 is a BLE advertising packet, the location data packet 38 is transmitted on one of the BLE advertising channels.

In step S3.3, the processing circuitry 32 causes the positioning packet 39 to be formed. The format of the positioning packet 39 is such that the Angle of Arrival of the positioning packet 39 can be determined by a multi-antenna array device 10 which receives the packet 39.

FIG. 6B shows an example of the format of a positioning packet 39 which may be formed by the processing circuitry 32 of the transmission apparatus 30. The formats of such packets are known in the art and so will not be discussed in detail here. As seen in FIG. 6B, the positioning packet 39 includes the angle-of-arrival field 391, which may also be referred to as the “AoA extension field”. It is during reception of the angle-of-arrival field 391 that the recipient device 10 switches between its antenna elements 12, such that different parts of the field 391 are received by different antenna elements 12. Based on this, the Angle or Angle of Arrival of the positioning packet 39 can be determined. The angle-of-arrival field 391 may comprise a pre-defined set of bits (for example, only l's) to which no data whitening is applied.

As will be appreciated, in examples in which the location data and the AoA field 391 are transmitted in the same packet, the AoA field 391 of FIG. 6B may be, for example, appended to a packet having the format of that shown in FIG. 6A.

Returning now to FIG. 3, in step S3.4, the processing circuitry 32 causes the positioning packet 39 to be transmitted. As mentioned above, the positioning packet 39 may be a BLE broadcast packet. The packet 39 may therefore be transmitted on one of the BLE broadcast channels. The particular channel(s) on which the packet is broadcast may be as indicated in the location data packet 38. Similarly, the interval between successive transmissions of positioning packets 39 may be as indicated in the location data packet 38.

FIG. 4 is a flow chart illustrating an example of operations which may be performed by the processing circuitry 14 of the multi-antenna array device 10 of FIG. 2B.

In operation S4.1, the processing circuitry 14 enables receipt at the multi-antenna array device 10 of the location data packet 39. This may simply comprise preparing the receiving functionality (for example, of the transceiver 16) to receive radio frequency packets. In examples in which the location data packet 38 is a BLE advertising packet, enabling receipt of the location data packet 38 may comprise monitoring the BLE advertising channels for transmitted BLE packets.

After receipt of the location data packet 38, the processing circuitry 14 parses the packet 38 to retrieve the location (and any other) data carried therein. Subsequently, in operation S4.2, the processing circuitry 14 stores the location data in the storage device 15. The processing circuitry 14 may, in some examples, also store the parameters relating to the subsequently transmitted positioning packet 39. These parameters may include the identifier of the transmission channel or channels on which the positioning packet is to be transmitted and/or the transmission interval at which successive transmission packets are to be transmitted.

In operation S4.3, the processing circuitry 14 monitors a transmission channel for incoming positioning packets 39. The monitored transmission channel may be that indicated in the location data packet 39. Alternatively, the monitored transmission channel may be determined in some other way or plural different channels may be monitored by cycling through different transmission channels successively until a positioning packet 39 detected.

In operation S4.4, the processing circuitry 14 enables receipt of the positioning packet 39 in such a way which allows determination as to the angle of arrival of the positioning packet 39. Specifically, this comprises switching between antenna elements 12A, 12B, 12C of the array 12 during receipt of the positioning packet 39. If the positioning packet has the format shown in FIG. 3B, the switching between antenna elements 12A, 12B, 12C is caused during receipt of the AoA extension field 391 of the positioning packet 39.

Next, in operation S4.5, the processing circuitry 14 determines the angle of arrival of the positioning packet 39. This may be performed based on the I and Q samples taken with each antenna element 12A, 12B, 12C during receipt of the positioning packet 39. For example, the angle of arrival of the may be determined based on the I and Q samples, as is described in WO2012/042315

In operation S4.6, the processing circuitry 14 uses the stored location data (including the coordinates of the transmission apparatus 30 and the elevation of the transmission to apparatus relative to the floor), which was extracted from the received location data packet 38, and the determined angle of arrival of the positioning packet 39 to determine the location of the multi-antenna array device 10.

The location of the multi-antenna array device 10 may be determined in operation S4.6 using an assumed orientation of the device 10. For example, the processing circuitry 14 may cause an instruction for the user to orientate the device 10 in a particular way to be provided to the user. For example, the user may be instructed to hold the device 10 horizontally and to align the device 10 with a particular physical feature of the space (for instance a corridor or a wall). The device 10 may then assume that user has done as instructed and thus assumes an orientation of the device 10 on that basis.

Alternatively, the orientation may be determined using a compass module 20 included in the device 10. The determined orientation of the device 10 may then be used in the location determination operation of S4.6.

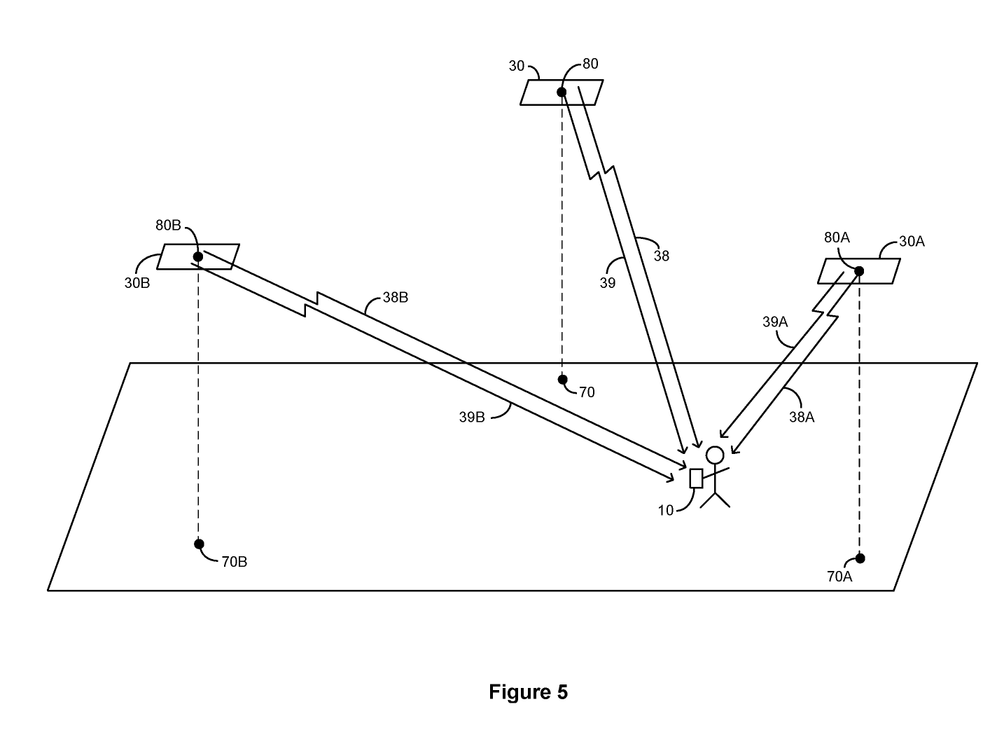

In a third alternative, the orientation of the device may not be known or assumed, but instead the multi-antenna array apparatus may use triangulation with respect to three transmission apparatuses 30, 30A, 30B, each at a different location 80, 80A, 80B, to determine its location. This is illustrated in FIG. 5.

In the example of FIG. 5, each of the three transmission apparatuses 30, 30A, 30B transmits a location data packet 38, 38A, 38B including information indicative of its location 80, 80A, 80B. Each location data packet 38, 38A, 38B is substantially as described above with reference to the previous Figures. Each of the transmission apparatuses 30, 30A, 30B also transmits a positioning packet 39, 39A, 39B which is received by the multi-antenna array device 10.

The processing circuitry 14 of the multi-antenna array device 10 is, addition to enabling receipt of the location data packet 38 and positioning packet 39 from the first transmission apparatus 30, configured also to enable receipt of the location data packet 38A and positioning packet 39A from a second one 30A of the transmission apparatuses. The multi-antenna array device 10 is configured also to enable receipt of the location data packet 38B and positioning packet 39B from a third one 30B of the transmissions apparatuses.

Based on the received positioning packets 39, 39A, 39B, the processing circuitry 14 determines the respective angles of arrival of the positioning packets 39, 39A, 39B from each of the three transmission apparatuses 30, 30A, 30B. The processing circuitry 14 then uses the locations of each transmission apparatus 30, 30A, 30B and the respective angles of arrival of the positioning packets 39, 39A, 39B to determine location of the multi-antenna array device 10.

As will be appreciated, each of the transmission apparatuses of FIG. 5 may, instead of transmitting separate location data and positioning packets 38, 39, transmit a single packet containing both the location data and the angle-of-arrival field 391.

Returning now to FIG. 4, in operation S4.7, the processing circuitry 14 plots the determined location of the apparatus on a map of the interior space and causes this to be displayed to the user via the user output device 18. The map data may be pre-stored in the storage device 15 or may be received via a communications interface, prior to it being displayed. In examples in which the building is multi-storey, the map data representing the correct floor may be selected based on the floor data included in the location data packet 38 (e.g. in the floor field 389).

It will, of course, be appreciated that the flow charts of FIGS. 3 and 4 are examples only and, as such, in other examples, the order of the operations may be different to that shown. For example, although benefits may be derived from the multi-antenna array device 10 receiving the location data packet 38 prior to the positioning packet 39 (for instance when the location data packet 38 includes signalling information relating to the positioning packet 39, such transmission channel and/or interval information), the positioning packet 38 may alternatively be received prior to the location data packet 38. As such, the order of operations S4.1 and S4.4 may be reversed. Similarly, it will be appreciated that certain operations shown in FIG. 4 may be omitted. For example, the determined location of the device 10 may be used for something other than plotting on a map in which case operation S4.7 may be omitted.

Examples of other variations to the flow charts of FIGS. 3 and 4 include operations S3.1 and S3.3 being combined such that a single packet containing both the location data 386, 387, 388, 389 and the angle-of arrival field 391 is formed. In such examples, the transmission operations of S3.2 and S3.4 may be combined into a single transmission operation. With regard to variations of the example of FIG. 4, operation S4.1 may be replaced by an operation in which the receipt of the single wirelessly-transmitted packet to containing both the location data 386, 387, 388, 389 and the angle-of-arrival field 391 is enabled. This operation may comprise switching between antennas of the array during receipt the angle-of-arrival field 391. In such examples, operations S4.3 and S4.4 are omitted.

Some further details of components and features of the above-described apparatuses 10, and alternatives for them will now be described.

The processing circuitry 14, 32 of the apparatuses 10, 30 of FIGS. 2A and 2B may be of any suitable composition and may include one or more processors 14A, 32A. For example, the processing circuitry 14, 32 may be a programmable processor that interprets computer program instructions and processes data. The processing circuitry 14, 32 may include plural programmable processors. Alternatively, the processing circuitry 14, 32 may be, for example, programmable hardware with embedded firmware. The processing circuitry may be termed processing means. The processing circuitry may alternatively or additionally include one or more Application Specific Integrated Circuits (ASICs).

The processing circuitry 14, 32 is coupled to the respective storage device 15, 34 and is operable to read/write data to/from the storage device 15, 34. The storage devices 15, 34 may comprise a single memory unit or a plurality of memory units, upon which the computer readable code 34A is stored. For example, the storage devices 15, 34 may comprise both volatile memory and non-volatile memory. For example, the computer readable instructions 15A, 34A may be stored in the non-volatile memory and may be executed by the processing circuitry 14, 32 using the volatile memory for temporary storage of data or data and instructions. Examples of volatile memory include RAM, DRAM, SDRAM etc. Examples of non-volatile memory include ROM, PROM, EEPROM, flash memory, optical storage, magnetic storage, etc.

The computer readable instructions 14A, 34A may be pre-programmed into the apparatuses 10, 30. Alternatively, the computer readable instructions 34A, 15A may arrive at the apparatus 30 via an electromagnetic carrier signal or may be copied from a physical entity 21 (see FIG. 2B) such as a computer program product, a memory device or a record medium such as a CD-ROM or DVD. The computer readable instructions 14A, 34A may provide the logic and routines that enables the devices/apparatuses 10, 30 to perform the functionality described above.

The BLE-capability of each of the apparatuses 10, 30 may be provided by a single integrated circuit. It may alternatively be provided by a set of integrated circuits (i.e. a chipset). The BLE-capability may alternatively be a hardwired, application-specific integrated circuit (ASIC).

Although the specific embodiments have been described primarily with reference to Bluetooth Low Energy (BLE), it will be appreciated that other protocols which allow angle of arrival of a packet to be determined may alternatively be used. Such protocols may include 802.11 wireless local area network protocols, other types of Bluetooth protocol, Ultra wideband (UWB) protocols or Zigbee protocols.

As will be appreciated, the apparatuses 10, 30 described herein may include various components which have not been shown in the Figures. For example, the mobile device 10 may comprise an additional communication interface which may be configured to allow two-way communication with external devices and/or networks. The communication interface may be configured to communicate wirelessly via one or more of several protocols such as Global System for Mobile Communications (GSM), Code Division Multiple Access (CDMA), Universal Mobile Telecommunications System (UMTS) and IEEE 802.11 (Wi-Fi). Alternatively or additionally, the communication interface 114 may be configured for wired communication with a device or network. The apparatuses 10, 30 may include other components depending on their nature. For example the mobile device 10, in embodiments in which it is a mobile telephone may further include components such as a microphone, a speaker, one or more camera modules and a vibration module to name but a few.

The apparatuses 10, 30 may comprise further optional SW components which are not described in this specification since they may not have direct interaction to embodiments of the invention.

Embodiments of the present invention may be implemented in software, hardware, application logic or a combination of software, hardware and application logic. The software, application logic and/or hardware may reside on memory, or any computer media. In an example embodiment, the application logic, software or an instruction set is maintained on any one of various conventional computer-readable media. In the context of this document, a “storage device” or “computer-readable medium” may be any media or means that can contain, store, communicate, propagate or transport the instructions for use by or in connection with an instruction execution system, apparatus, or device, such as a computer.

Reference to “computer-readable storage medium”, “computer program product”, “tangibly embodied computer program” etc, or a “processor” or “processing circuitry” etc. should be understood to encompass not only computers having differing architectures such as single/multi processor architectures and sequencers/parallel architectures, but also specialised circuits such as field programmable gate arrays FPGA, application specify circuits ASIC, signal processing devices and other devices. References to computer program, instructions, code etc. should be understood to express software for a programmable processor firmware such as the programmable content of a hardware device as instructions for a processor or configured or configuration settings for a fixed function device, gate array, programmable logic device, etc.

As used in this application, the term ‘circuitry’ refers to all of the following: (a) hardware-only circuit implementations (such as implementations in only analog and/or digital circuitry) and (b) to combinations of circuits and software (and/or firmware), such as (as applicable): (i) to a combination of processor(s) or (ii) to portions of processor(s)/software (including digital signal processor(s)), software, and memory(ies) that work together to cause an apparatus, such as a mobile phone or server, to perform various functions) and (c) to circuits, such as a microprocessor(s) or a portion of a microprocessor(s), that require software or firmware for operation, even if the software or firmware is not physically present.

This definition of ‘circuitry’ applies to all uses of this term in this application, including in any claims. As a further example, as used in this application, the term “circuitry” would also cover an implementation of merely a processor (or multiple processors) or portion of a processor and its (or their) accompanying software and/or firmware. The term “circuitry” would also cover, for example and if applicable to the particular claim element, a baseband integrated circuit or applications processor integrated circuit for a mobile phone or a similar integrated circuit in server, a cellular network device, or other network device.

The term ‘memory’ when used in this specification is intended to relate primarily to memory comprising both non-volatile memory and volatile memory unless the context implies otherwise, although the term may also cover one or more volatile memories only, one or more non-volatile memories only, or one or more volatile memories and one or more non-volatile memories.

If desired, the different functions discussed herein may be performed in a different order and/or concurrently with each other. Furthermore, if desired, one or more of the above-described functions may be optional or may be combined.

Although various aspects of the invention are set out in the independent claims, other aspects of the invention comprise other combinations of features from the described embodiments and/or the dependent claims with the features of the independent claims, and not solely the combinations explicitly set out in the claims.

It is also noted herein that while the above describes example embodiments of the invention, these descriptions should not be viewed in a limiting sense. Rather, there are several variations and modifications which may be made without departing from the scope of the present invention as defined in the appended claims.

1-73. (canceled)

74. A method comprising:
receiving, at a multi-antenna array device from a remote device, at least one wirelessly transmitted packet including location data indicative of a location of the remote device and including an angle-of-arrival field for enabling determination of an angle of arrival of the wirelessly transmitted packet in which the angle-of-arrival field is provided;
determining based on the received angle of arrival field, the angle of arrival of the wirelessly transmitted packet in which the angle-of-arrival field is provided; and
determining a location of the multi-antenna array device based on at least the determined angle of arrival and the location data.

75. The method of claim 74, wherein at least one of:
a) the location data includes coordinate information indicative of the coordinates of the remote device;
b) the location data includes elevation information indicative of an elevation of the remote device;
c) the location data includes information indicative of a storey on which the remote device is located;
d) the location data and the angle-of-arrival field are provided in the same wirelessly-transmitted packet; and
e) the location data is provided in a location data packet and the angle-of-arrival field is provided in a separately-transmitted positioning packet.

76. The method of claim 75, wherein the location data packet includes information indicative of a transmission channel of the positioning packet and/or a transmission interval associated with the positioning packet.

77. The method of claim 74, wherein determining the location of the multi-antenna array device is based on an assumed orientation of the multi-antenna array device or a detected orientation of the multi-antenna array device.

78. The method of claim 74, comprising:
receiving at the multi-antenna array device from a second remote device at least one wirelessly transmitted packet including location data indicative of a location of the second remote device and including a second angle-of-arrival field;
determining based on the received second angle-of-arrival field, an angle of arrival of the wirelessly transmitted packet in which the second angle-of-arrival field is provided;
receiving at the multi-antenna array device from a third remote device, at least one wirelessly transmitted packet including location data indicative of a location of the third remote device and including a third angle-of-arrival field;
determining based on the received third angle-of-arrival field, an angle of arrival of the wirelessly transmitted packet in which the third angle-of-arrival field is provided; and
determining the location of the multi-antenna array device based on at least the angles of arrival of the wirelessly-transmitted packet in which the angle-of-arrival field is provided, the wirelessly-transmitted packet in which the second angle-of-arrival field is provided and the wirelessly-transmitted packet in which the third angle-of-arrival field is provided and on the locations of the remote device, the second remote device and the third remote device.

79. The method of claim 74, wherein the multi-antenna array device is a mobile device.

80. The method of claim 74, wherein the remote device is a Bluetooth Low Energy-capable tag.

81. Apparatus comprising:
at least one processor; and
at least one memory including computer program code, the at least one memory and the computer program code configured to, with the at least one processor, cause the apparatus at least to:
receive, at a multi-antenna array device from a remote device, at least one wirelessly transmitted packet including location data indicative of a location of the remote device and an angle-of-arrival field for enabling determination of an angle of arrival of the wirelessly transmitted packet in which the angle-of-arrival field is provided;
determine based on the received angle of arrival field, the angle of arrival of the wirelessly transmitted packet in which the angle-of-arrival field is provided; and
determine a location of the multi-antenna array device based on at least the determined angle of arrival and the location data.

82. The apparatus of claim 81, wherein at least one of:
a) the location data includes coordinate information indicative of the coordinates of the remote device;
b) the location data includes elevation information indicative of an elevation of the remote device;
c) the location data includes information indicative of a storey on which the remote device is located;
d) the location data and the angle-of-arrival field are provided in the same wirelessly-transmitted packet; and
e) the location data is provided in a location data packet and the angle-of-arrival field is provided in a separately-transmitted positioning packet.

83. The apparatus of claim 81, wherein the location data packet includes information indicative of a transmission channel of the positioning packet and/or a transmission interval associated with the positioning packet.

84. The apparatus of claim 81, the at least one memory and the computer program code configured to, with the at least one processor, cause the apparatus to determine the location of the multi-antenna array device based on an assumed orientation of the multi-antenna array device or a detected orientation of the multi-antenna array device.

85. The apparatus of claim 81, wherein the multi-antenna array device is a mobile device.

86. The apparatus of claim 81, wherein the remote device is a Bluetooth Low Energy-capable tag.

87. Apparatus comprising:
at least one processor; and
at least one memory including computer program code, the at least one memory and the computer program code configured to, with the at least one processor, cause the apparatus at least to:
transmit from a remote device of at least one wirelessly transmitted packet including location data indicative of a location of the remote device and an angle-of-arrival field for enabling a multi-antenna array device to determine an angle of arrival, at the multi-antenna array device, of the wirelessly transmitted packet in which the angle-of-arrival field is transmitted.

88. The apparatus of claim 87, wherein at least one of:
a) the location data includes coordinate information indicative of the coordinates of the remote device;
b) the location data includes elevation information indicative of an elevation of the remote device;
c) the location data includes information indicative of a storey on which the remote device is located;
d) the location data and the angle-of-arrival field are provided in the same wirelessly-transmitted packet; and
e) the location data is transmitted in a location data packet and the angle-of-arrival field is transmitted in a separately-transmitted positioning packet.

89. The apparatus of claim 87, wherein the location data packet includes information indicative of a transmission channel of the positioning packet and/or a transmission interval associated with the positioning packet.

90. The apparatus of claim 87, wherein the apparatus is a Bluetooth Low Energy-capable tag.
